(19) United States
(12) Patent Application Publication
(10) Pub. No.: US 2017/0352081 A1
(43) Pub. Date: Dec. 7, 2017

(54) PLATFORM FOR BUYING AND SELLING CONSUMER ELECTRONIC GOODS

(71) Applicant: ALAN SOLARINO, KINNELON, NJ (US)

(72) Inventor: ALAN SOLARINO, KINNELON, NJ (US)

(21) Appl. No.: 15/614,052

(22) Filed: Jun. 5, 2017

Related U.S. Application Data
(60) Provisional application No. 62/345,518, filed on Jun. 3, 2016.

(51) Int. Cl. G06Q 30/06; G06Q 20/40

(52) U.S. Cl. CPC G06Q 30/0611; G06Q 30/0637; G06Q 20/4012; G06Q 30/0613; G06Q 30/0631

(57) ABSTRACT

The present disclosure describes a system that not only facilitates the emergence of the used consumer electronics market, but also provides MNOs with an opportunity to acquire and retain customers even though they did not directly sell the particular consumer electronic good or device to the present end user. Further, the platform offers carrier operated equipment installment plans enabling payments for the used devices to be made in monthly installments along with their typically monthly billing payments.

### CLAIM OF PRIORITY

This application claims priority to U.S. Application 62/345,518 filed on Jun. 3, 2016, the contents of which are herein fully incorporated by reference in its entirety.

### FIELD OF THE EMBODIMENTS

The field of the embodiments of the present invention relate to a method and system for facilitating the purchase of electronic goods capable of being connected to a communications network, particularly cellular phones, via a marketplace and offering particular mechanisms of payment for the electronic goods.

### BACKGROUND OF THE EMBODIMENTS

The consumer electronics market is one of the fastest growing marketplaces in this country and around the world today. The market moves at such a pace that one's goods can essentially become “obsolete” after a very short time frame. Manufacturers are consistently providing users with electronic devices having faster, more efficient processors, increased storage space, and improved peripherals amongst a multitude of other parameters. Thus, it is commonplace for a consumer or user to upgrade their electronic goods to keep pace with the technological prowess of the providers.

However, not everyone can afford to consistently upgrade or make new purchases in order to have the latest and greatest in consumer electronics technology. It is estimated that more than 400 million of the 1.4 billion smartphones sold in 2015 will be resold and used by another party after its original owner decides to part with the device. The reselling of consumer electronics, particularly cellular phones, is so lucrative that the used smartphone market is expected to grow about four to five times faster than the new smartphone market over the coming years. Thus, there is a strong demand for used electronics, particularly cellular phones, but limited means to get these used phones to the interested consumer.

Further, two recent developments in the wireless service industry have effected a shift in consumer behavior thereby drawing consumers to buying/selling platforms: 1) wireless carriers' abandonment of cellular phones subsidized by multi-year contracts and 2) legislation requiring carriers to “unlock” phones not under financing so that the cellular phones may be used on other carriers' networks.

As a result, fewer and fewer consumers are bound by their electronic device(s) to any one carrier and an increasing number are using third parties to buy and sell new and used phones, many of which are already “unlocked.” Other consumer electronics that utilize wireless carriers' networks to connect to the Internet or other communications network include but are not limited to smart watches, tablets, etc. These consumer electronic goods are subject to the same influences and similarly traded in the marketplace.

Notwithstanding the above, such buying/selling platforms do exist, to an extent, but have not fully grasped the scope of this emerging marketplace nor have they reconciled the opportunities to partner with the mobile network operators (MNOs) also known as wireless service providers, wireless carriers, cellular companies, or mobile network carriers. These MNOs are a provider of wireless communications services that own or control most all the elements necessary to sell and deliver these services to an end user or consumer. Present selling platforms such as Amazon or eBay simply allow an individual or group to buy and/or sell a new or used consumer electronic device or good. The MNOs are not involved nor do they have the ability to effectively target consumers purchasing electronic devices from third-party selling platforms.

Thus, there is a need for a marketplace that allows new and/or used cellular phones (and other applicable consumer electronic goods) to be purchased and further allows the MNOs to retain and potentially acquire new customers. The present invention and its embodiments describes and teaches a system that not only facilitates the emergence of the used cellular phone market, but also enables the MNOs an opportunity to acquire and retain customers through new and used consumer electronic goods purchases even though they did not directly sell the cellular phone to the present end user. As such, the present invention and its embodiments meets the needs and objectives required in the current marketplace to capitalize on the used cellular phone market or the third-party connected electronic device market.

### Review of Related Technology:

U.S. Pat. No. 6,314,283 pertains to a cellular phone subsidy lock which ensures that a cellular phone, sold to an end-user at a price subsidized by a cellular carrier, is activated only on the subsidizing carrier's network, and not on a competitor's network. A secure carrier code, specific to and known by the subsidizing carrier, is programed into the cellular phone by the phone manufacturer. The phone is programmed and shipped by the manufacturer in a locked condition, which prevents programming of the NAM (Number Assignment Module) of the cellular phone without first entering either a valid unlock code or a valid remove lock code.

At the time of phone activation and programming of the NAM, the phone's ESN (Electronic Serial Number) is entered into the carrier computer system, which utilizes the ESN and carrier code to execute a subsidy lock algorithm which outputs an unlock code and a remove lock code. At the carrier's choice, either code is given to the end user to be entered into the phone. The phone then executes the same subsidy lock algorithm, using the carrier code programmed at the time of manufacture, and its own ESN, to calculate the unlock code and the remove lock code. If the code entered by the user matches the unlock code, NAM programming is allowed to proceed only once, and if the entered number matches the remove lock code, the phone removes the subsidy lock completely.

U.S. Patent Application 2011/0320303 pertains to an online offer system directed towards methods and devices that allow a seller to enter information about the attributes of a non-fungible good based on parameter values provided on a database. In response, an automated purchaser issues a firm offer to purchase the good at a set price.

Various devices and methodologies are known in the art. However, their structure and means of operation are substantially different from the present disclosure. At least one embodiment of this invention is presented in the drawings below and will be described in more detail herein.

### SUMMARY OF THE EMBODIMENTS

In general, the present invention and its embodiments teach and describe a system that not only facilitates the emergence of the used cellular phone market, but also provides MNOs with an opportunity to acquire and retain customers buying new or used devices even though they are not directly selling the cellular phone to the purchasing consumer. Further, the platform offers a consumer the option to pay for a connected device through a carrier-operated equipment installment plan (EIP) consisting of a number of monthly installments itemized on and payable by the consumer through their monthly wireless service bill.

For example, a third party may list a cellular phone or other electronic device for sale via a listing or database on a communications network such as the internet. The listing may conform to various parameters (as laid out by an MNO) and may include the opportunity to purchase the cellular phone under an equipment installment plan or EIP. A user may then select to purchase the phone but in lieu of paying in full for the phone at the time of purchase, the user may opt to pay for the phone in installments to the MNO per the EIP.

In one embodiment of the present invention there is a system providing a consumer electronics sales platform, the system comprising: a processor having a computer readable storage medium configured to store one or more programs for execution by the processor, wherein the one or more programs has machine readable instructions that when executed by the processor cause the following steps to be performed, establishing, by a third party, eligibility parameters for at least one electronic device, establishing, by a vendor, purchase parameters for the at least one electronic device, selecting, by a purchaser, the at least one electronic device, selecting, by the purchaser, a method of payment associated with the at least one electronic device, wherein the method of payment is an equipment installment plan, at least one shipping kit and/or instructions, provided by the processor, containing information supplied by the purchaser; and at least one transaction identifier provided by the processor, wherein the transaction identifier is required to release the at least one electronic device to the purchaser.

In another embodiment of the present invention there is a method of buying and selling consumer electronic goods, the method comprising the steps of: establishing, by at least one mobile network operator, purchase parameters for an electronic device that is eligible for inclusion on a network of the at least one mobile network operator; listing, by a vendor, at least one connected electronic device, the at least one connected electronic device being compatible with at least one network associated the at least one mobile network operator; selecting, by a purchaser, the at least one connected electronic device; selecting, by the purchaser, a method of payment associated with the at least one electronic device; wherein the method of payment is an equipment installment plan; providing, to the vendor via a processor, shipping instructions; providing, to the purchaser via the processor, a transaction identifier, wherein the transaction identifier is required to be provided to a third party to release the at least one connected electronic device to the purchaser.

In yet another embodiment of the present invention there is a non-transitory computer readable memory configured to store one or more programs for execution by a processor, wherein the one or more programs has machine readable instructions that when executed by the processor cause the following steps to be performed, establishing, by at least one mobile network operator, purchase parameters for an electronic device that is eligible for inclusion on a network of the at least one mobile network operator, listing, by a vendor, at least one connected electronic device, the at least one connected electronic device being compatible with at least one network associated the at least one mobile network operator, selecting, by a purchaser, the at least one connected electronic device, selecting, by the purchaser, a method of payment associated with the at least one electronic device, wherein the method of payment is an equipment installment plan, providing, to the vendor via the processor, a shipping instructions, and providing, to the purchaser via the processor, a transaction identifier, wherein the transaction identifier is required to be provided to a third party to release the at least one connected electronic device to the purchaser.

In general, the present invention succeeds in conferring the following, and others not mentioned, benefits and objectives.

It is an object of the present invention to provide a platform for consumers to purchase used consumer electronics.

It is an object of the present invention to provide a platform that enables wireless carriers to market used consumer electronics directly to consumers.

It is an object of the present invention to provide a platform that facilitates consumers purchasing a used electronic good at an affordable price.

It is an object of the present invention to provide a platform that offers consumers carrier operated equipment installment plans (EIPs).

It is an object of the present invention to provide a platform for consumers to purchase connected consumer electronics.

It is an object of the present invention to provide a platform that enables wireless carriers to market their services to consumers as part of the purchase process of connected devices.

It is an object of the present invention to provide a platform that offers consumers confidence that their purchased connected device will operate on their wireless provider's network and recourse should it not.

It is an object of the present invention to provide a platform that offers consumers the convenience and affordability of paying with a carrier-operated installment plans for connected devices not purchased from a wireless carrier.

### BRIEF DESCRIPTION OF THE DRAWINGS

FIG. 1 is a flowchart illustrating a process via which an MNO identifies a connected device eligible for purchase with an MNO-operated EIP.

FIG. 2A is a flowchart describing a purchasing and shipping process in accordance with the present invention.

FIG. 2B is a flowchart illustrating a continuation of the process described in FIG. 2A, elaborating on acceptance of the goods and enrollment in an EIP.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

### Systems, Devices and Operating Systems

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations.

One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present invention may be connected to and/or communicate with entities such as, but not limited to: one or more users from user input devices; peripheral devices; an optional cryptographic processor device; and/or a communications network. For example, the present invention may be connected to and/or communicate with users, operating client device(s), including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network.

A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

Computer Systemization

A computer systemization may comprise a clock, central processing unit (“CPU(s)” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus.

In another embodiment, the cryptographic processor and/or transceivers may be connected as either internal and/or external peripheral devices via the interface bus I/O. In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like.

The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc.

The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the features of the present invention.

A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present invention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention.

A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like.

One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composite information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices, such as other components of the system may be connected and/or communicate to I/O and/or other facilities of the like such as network interfaces, storage interfaces, directly to the interface bus, system bus, the CPU, and/or the like. Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam, etc.), drive motors, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation.

In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millennium/NT/Vista/XP (Server), Palm OS, and/or the like. The operating system may be one specifically optimized to be run on a mobile computing device, such as iOS, Android, Windows Phone, Tizen, Symbian, and/or the like. An operating system may communicate to and/or with other components in a component collection, including itself, and/or the like.

Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like.

The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the controller of the present invention based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.”

Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields.

In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millennium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices.

A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invention.

Access to the mail of the present invention may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network.

The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

A Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

Embodiments of the Present Invention

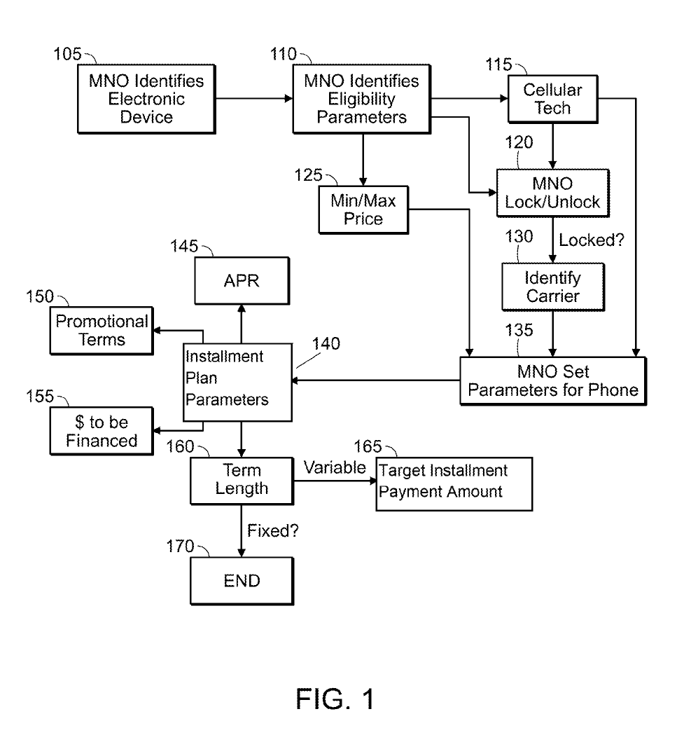

In FIG. 1, there is a flowchart illustrating a methodology associated with the setting up of an MNO payment plan to be offered as a form of payment for an electronic device listing on a third-party platform. In a preferred embodiment, the electronic device described herein is a cellular phone such as a smart phone. However, in other embodiments the electronic device is a gaming system, lap top computer, desktop computer, tablet, PDA, smart watch, head mounted display, media player, music player, and the like or some combination thereof. It is preferable that the present system is useful for “used” electronic devices or goods, although new or unused devices may also be utilized under the purview of the present invention.

Further, such devices (new or used) may or may not be contained within a MNO's inventory, however, the MNO may be able to obtain control of the device on their network via a purchase from a consumer. Such opportunity, of course, assumes that the device qualifies for the parameters enabled by the MNO.

The database of the present invention may be an online database accessible via an electronic device capable of communicating with a communications network such as the internet. The database may take the form of a program or application capable of being run on a mobile device and may be accessed remotely (i.e. from the cloud).

Referring now to FIG. 1, in box 105, an MNO identifies an electronic device to be eligible for an equipment installment plan or EIP. The MNO may identify an electronic device via a whitelist file, a real time inquiry, an approved listing, etc. In some embodiments, one (user) can drill down between models, parameters, etc. to find the particular electronic device desired for purchase. The MNO, while not creating the listing directly, sets forth these parameters such that the buying/selling platform can query the invention's database to determine if the particular device qualifies for an EIP on a particular MNO's network. This prevents MNOs from making EIP offers on new and/or used consumer electronic goods that do not meet their business requirements or for which their network cannot support.

In box 110, the MNO identifies the eligibility parameters of the listing. This may include but is not limited to the cellular operating network (CDMA vs. GSM), as shown in box 115, the minimum and maximum purchase prices as shown in box 125, and the ability to use the phone in conjunction with various carriers, as shown in box 120. If the electronic device can only be used with a particular carrier, it is desirable that this carrier is identified and configured to be filtered via a user query as shown in box 130. Some eligibility requirements may require the execution of external actions to fulfill. Examples include querying an external database to determine if the electronic device has been reported stolen, is currently being financed, or is otherwise ineligible for activation on an MNO's network. A diagnostic assessment performed by a designated application or provider may also be employed to determine device eligibility for used or refurbished devices.

In box 135, the MNO will set the offer parameters of an EIP for each electronic device or group of electronic devices. The EIP parameters, shown in box 140, may include a dollar amount (including a minimum and maximum to be financed—box 155), an annual percentage rate (APR) as shown in box 145, promotional terms as shown in box 150, and a term length as shown in box 160. If the term length is variable a target installment payment price is provided as shown in box 165, otherwise the process ends in box 170.

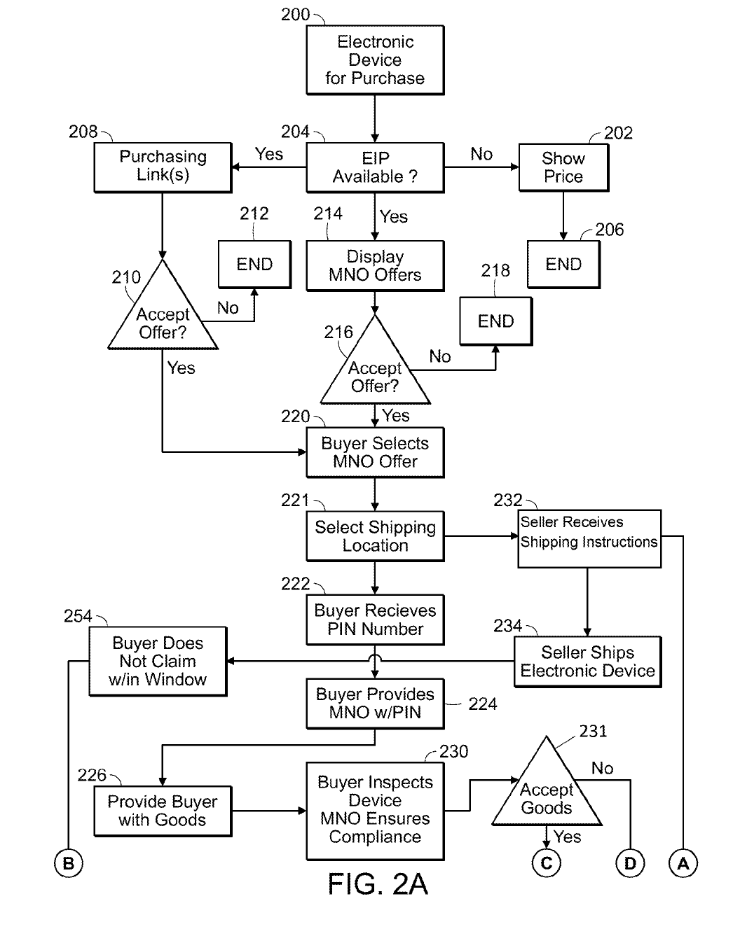

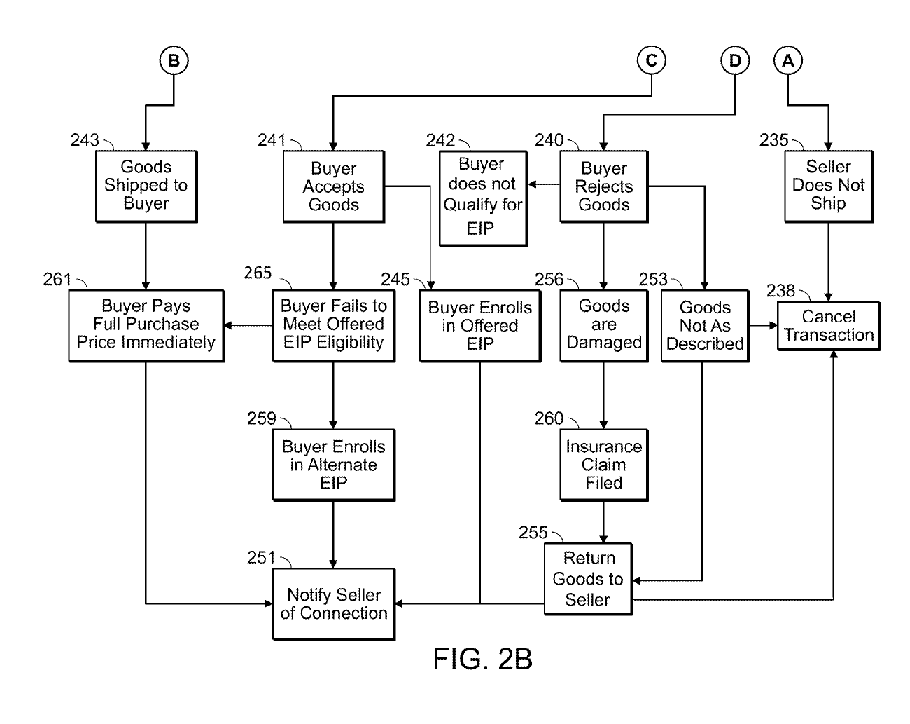

Referring now to FIGS. 2A-2B, there is a flowchart illustrating an outline of an embodiment of the buying process for a prospective buyer and selling process for the vendor. Since the vendor has created a listing, via an electronic database, for the electronic device(s) a user can now access a database listing that device to ascertain whether the user would like to buy the particular electronic device. Such a database may require a subscription or user profile in order to access the full database listing. In other embodiments, the database may be readily accessed by any user of a communication network.

In a box 200, there is an electronic device that has been listed for purchase by a third party supplier. Such a supplier may be a resale company, an originating company, an individual, and the like or some combination thereof. As shown in box 204, there may be an EIP available for the user interested in purchasing the electronic device. If no EIP is available, as shown in box 202, then the consumer experience continues as it would without the invention and the process ends in box 206.

However, if an EIP is available a user may be presented with a number of potential purchasing links as shown in box 208 or a listing of potential offers as shown in box 214. For example, the user may receive a link in the form of a “get it now” icon which enables a user to receive the product for agreeing to the terms of the EIP displayed on the screen. This may take the form of a statement such as “buy for as low as $xx.xx per month.” By clicking on this link, the prospective purchaser may be taken to a subsequent page detailing a number of offers at different prices and the compatibility of each offer with each MNO network. Alternatively, the prospective purchaser may simply be greeted with the individual offer from the MNO for which the device is eligible.

Alternatively, a user is initially presented with a list of all MNO offers. This may include a breakdown of a price per month listing, special promotions, or other information associated with the electronic device. If the user does not accept any of the potential offerings, as shown in boxes 210 or 216, then the process may end as shown in boxes 212 and 218 respectively. The user may then conduct the same or a similar investigative process on any other number of electronic devices by running any other number of queries.

In box 220, the user selects the MNO offer of the EIP. In box 221, the user or buyer or purchaser selects the shipping location for the consumer electronic device. The shipping location is such that it must be to a location that is capable of activating the device on the MNO's network. Thus, the user may have a limited number of options for locations in their area determined by eligible locations and the user's location.

In box 232, the seller then receives shipping instructions. The shipping instructions may contain the MNO-approved location selected by the consumer to which the phone should be shipped and a transaction ID to place on the exterior of the shipping packaging. The seller can then ship the device as shown in box 234. Alternatively, this information may be provided in the form of a pre-printed label. However, the location must be a pre-approved location of the MNO whose offer was accepted since, as part of the offer acceptance process, the purchaser would be required to select a location from the MNO's list.

The buyer or purchaser is provided with, as shown in box 222, a unique transaction number, email confirmation, and buyer PIN required in order to pick up the electronic device from the delivery location chosen by the buyer/purchaser. Once the packaged goods arrives at the pre-approved MNO location, the buyer will be notified of the arrival of the package. The buyer can then, as shown in box 224, arrive at the pre-approved MNO location and provide the transaction number, buyer PIN, or a combination thereof in order to have the package released as shown in box 226. The inability of the MNO to activate the device on the MNO network may result in the buyer rejecting the goods as shown in box 240.

In some embodiments, as shown in box 230, the buyer or user may be able to inspect the goods or devices purchased. This enables the buyer to determine that the goods meet the specifications laid out by the vendor or seller and further allows the buyer to ascertain the device is in a proper operating condition. The buyer may then accept the goods or reject the goods as shown in box 231. Further at this point in the transaction, in box 230, the MNO is able to verify that the device or good is indeed compatible or compliant with their network. An additional step, in some embodiments, may be required to be performed by the MNO involving configuring the actual device to be operational on the MNO network. This may involve a “registering” of the device with the network or other proprietary configuration on part of the MNO.

The buyer, as noted above, may accept the goods as shown in box 241 or may reject the goods as shown in box 240. If the buyer accepts the goods, then the buyer may enroll in the agreed upon EIP, as shown in box 245, or the buyer may need to conduct further business in order to enter into the EIP. If the buyer ultimately fails to qualify for the previously accepted EIP, as shown in box 265, the buyer may enter into an alternate EIP offered, as shown in box 259, by the MNO or elect to immediately pay for the goods in full, as shown in box 261, to receive the electronic device. Once payment is made via either enrollment in an EIP or the buyer's election to immediately pay for the device in full, the MNO notes the respective choice, notifies the seller, as shown in box 251, and completes the transaction. In some embodiments, if the buyer fails to qualify for the originally accepted EIP or an alternate EIP, the buyer may elect to reject the goods, as shown in box 240.

The buyer may be given a period of time to obtain the goods once their arrival at the MNO location is communicated to the buyer. If the buyer does not claim the goods within the time period, as shown in box 254, the goods shall be deemed accepted by the buyer and will be shipped by the MNO to the alternate address provided by the buyer at the time of purchase, using the address provided by the buyer to the vendor at the time of purchase as shown in box 243. The vendor will be notified of the failure to pick up and charged the full agreed purchase price for the goods. In some embodiments, the vendor may also be charged a fee for the buyer's failure to pick up the device. The vendor may then pass these charges on to the buyer through a previously established funding mechanism.

Alternatively, the buyer may be given a grace period for which it can still obtain the goods from the MNO prior to the assessment of the purchase price or fee for failure to pick up.

However, in some events, the process may not be fully completed by the purchaser or the vendor. For example, in FIG. 2B, as shown in box 235 the seller may not ship the phone. Such an action may be intentional or simply an oversight. Regardless, if not cured within a certain timeframe the sale will be canceled as shown in box 238 and the purchaser is free to choose another electronic device.

Thus, if no shipping information is received by system within a predetermined number of days, the seller may be notified of the lack of the provided information. The buyer may be notified of the delay by the system. If no information is provided subsequent to these actions, the transaction will be canceled and such a failure to ship will be flagged in the seller's record/profile. Some fees may be applied to and be responsible by the seller in such a failure to ship.

Alternatively, the buyer or purchaser may reject the goods for a number of reasons. As shown in box 240, the buyer may reject the goods upon arrival. The buyer may reject the goods if they have been damaged in transit as shown in box 256 or are not as described in the sale listing as shown in box 253.

If the buyer rejects the device, because they are not as described in the sale listing, then the device or goods may be returned to the seller and the transaction canceled, as shown in box 238. In such a scenario, the MNO identifies the reason for return and generates a shipping label. The system can then notify (electronically) the seller that the device is in the return process and the reason for the return. The buying/selling platform may then further note the IMEI and may flag the seller's profile if the reason for return was such that the device was deficient or did not meet the standards of the product listing. The appropriate fees may then be assessed and returned to the respective parties.

If the goods are damaged in transit, then an insurance claim may be initiated, as shown in box 260, with the goods returned to the seller as shown in box 255, and culminating with the seller being credited for the cost of the goods as provided by the insurance. The transaction may then be closed. The buyer is notified and the transaction is closed allowing the buyer to begin another transaction.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A system providing a consumer electronics sales platform, the system comprising:
a processor having a computer readable storage medium configured to store one or more programs for execution by the processor, wherein the one or more programs has machine readable instructions that when executed by the processor cause the following steps to be performed,
establishing, by a MNO, eligibility parameters for at least one electronic device,
establishing, by a MNO, the parameters of at least one equipment installment plan,
establishing, by a MNO, the authorization to offer the at least one electronic device meeting the eligibility parameters for the at least one device, the at least one equipment installment plan defined,
establishing, by a vendor, purchase parameters for the at least one electronic device that include presentation of the at least one equipment installment plan as a method of payment,
selecting, by the purchaser, the at least one electronic device, selecting, by the purchaser, a method of payment associated with the at least one electronic device,
wherein the method of payment is an equipment installment plan, at least one set of shipping instructions, provided by the processor, containing information supplied by the purchaser; and
at least one transaction identifier provided by the processor,
wherein the transaction identifier is required to release the at least one electronic device to the purchaser.

2. The system of claim 1 wherein the at least one electronic device is shipped to a third party, and wherein the third party releases the at least one electronic device to the purchaser.

3. The system of claim 2 wherein the third party is a mobile network operator or an agent of the mobile network operator.

4. The system of claim 1 wherein the at least one electronic device is capable of being coupled to a communications network.

5. The system of claim 1 wherein the equipment installment plan comprises monthly payments, itemized on the purchasers monthly service bill, payable towards the at least one electronic device.

6. A method of buying and selling consumer electronic goods, the method comprising the steps of:
establishing, by at least one mobile network operator, at least one equipment installment plan to be offered as a payment option for at least one connected electronic device that meet a set of eligibility criteria;
listing, by a vendor, at least one connected electronic device, the at least one connected electronic device being compatible with at least one network associated the at least one mobile network operator;
selecting, by a purchaser, the at least one connected electronic device;
selecting, by the purchaser, a method of payment associated with the at least one electronic device;
wherein the method of payment is an equipment installment plan;
providing, to the vendor via a processor, shipping instructions to a third party, wherein the third party is a mobile network operator or an agent of the mobile network operator; and
providing, to the purchaser via the processor, a transaction identifier,
wherein the transaction identifier is required to be provided to a third party to release the at least one connected electronic device to the purchaser.

7. The method of claim 6 wherein the method of payment is applied to a monthly invoice payable by the purchaser to the mobile network operator.

8. The method of claim 6 further comprising the step of:
the purchaser accepting or rejecting the at least one connected electronic device,
wherein if the purchaser accepts the at least one connected electronic device, then the at least one connected electronic device is released to the purchaser; and
wherein if the purchaser rejects the at least one connected electronic device, then the at least one connected electronic device is returned to the vendor.

9. The method of claim 6 wherein the at least one connected electronic device is configured to be coupled to a communications network.

10. The method of claim 6 further comprising the step of:
configuring the at least one connected electronic device to be operable on the network of the at least one mobile network operator.

11. A non-transitory computer readable memory configured to store one or more programs for execution by a processor, wherein the one or more programs has machine readable instructions that when executed cause the following steps to be performed:
establishing, by at least one mobile network operator, purchase parameters for an electronic device that is eligible for inclusion on a network of the at least one mobile network operator;
listing, by a vendor, at least one connected electronic device, the at least one connected electronic device being compatible with at least one network associated the at least one mobile network operator;
selecting, by a purchaser, the at least one connected electronic device;
selecting, by the purchaser, a method of payment associated with the at least one electronic device,
wherein the method of payment is an equipment installment plan;
providing, to the vendor via a processor, shipping instructions to a third party, wherein the third party is a mobile network operator or an agent of the mobile network operator; and
providing, to the purchaser via the processor, a transaction identifier,
wherein the transaction identifier is required to be provided to a third party to release the at least one connected electronic device to the purchaser.
